(19) United States
(12) Patent Application Publication
(10) Pub. No.: US 2026/0288173 A1
(43) Pub. Date: Sep. 24, 2026

(54) METHOD AND SYSTEM FOR CONTROLLING A ROBOT

(71) Applicant: Bear Robotics, Inc., Redwood City, CA (US)

(72) Inventors: Trung NGUYEN, Mesquite, TX (US); Kevin RABIDEAU, Redwood City, CA (US)

(73) Assignee: Bear Robotics, Inc., Redwood City, CA (US)

(21) Appl. No.: 19/473,341

(22) PCT Filed: Apr. 5, 2024
(86) PCT No.: PCT/US2024/023302

§ 371 Date: Oct. 7, 2025

Related U.S. Application Data
(60) Provisional application No. 63/458,210, filed on Apr. 10, 2023.

(51) Int. Cl. G05D 1/698

(52) U.S. Cl. CPC G05D 1/6983

(57) ABSTRACT

According to one aspect of the present invention, there is provided a method for controlling a robot, the method comprising the steps of: determining an exclusion zone in a space where a robot travels; and determining whether the robot is capable of occupying the exclusion zone.

### CROSS-REFERENCE TO RELATED APPLICATIONS

This application claims the benefit of U.S. Provisional Application No. 63/458,210 filed on Apr. 10, 2023, the entire contents of which are herein incorporated by reference.

### FIELD OF THE INVENTION

The present invention relates to a method and system for controlling a robot.

### BACKGROUND

In a space where robots are traveling, certain areas may be more congested due to the nature of the areas, the density of visitors, and the like. If a large number of robots occupy these areas without restriction, the congestion is bound to increase. This not only reduces the efficiency of space operation, but also reduces the efficiency of robot operation.

### SUMMARY OF THE INVENTION

One object of the present invention is to solve all the above-described problems in the prior art.

Another object of the invention is to set an exclusion zone that only a limited number of robots can occupy in a space where robots are traveling, thereby increasing the efficiency of space operation and robot operation.

The representative configurations of the invention to achieve the above objects are described below.

According to one aspect of the invention, there is provided a method for controlling a robot, the method comprising the steps of: determining an exclusion zone in a space where a robot travels; and determining whether the robot is capable of occupying the exclusion zone.

According to another aspect of the invention, there is provided a system for controlling a robot, the system comprising: a first determination unit configured to determine an exclusion zone in a space where a robot travels; and a second determination unit configured to determine whether the robot is capable of occupying the exclusion zone.

In addition, there are further provided other methods and systems to implement the invention, as well as non-transitory computer-readable recording media having stored thereon computer programs for executing the methods.

According to the invention, it is possible to set an exclusion zone that only a limited number of robots can occupy in a space where robots are traveling, thereby increasing the efficiency of space operation and robot operation.

### BRIEF DESCRIPTION OF THE DRAWINGS

FIG. 1 schematically shows the configuration of an entire system for controlling a robot according to one embodiment of the invention.

FIG. 2 illustratively shows the structure of a robot according to one embodiment of the invention.

FIG. 3 illustratively shows the structure of a robot according to one embodiment of the invention.

FIG. 4 specifically shows the internal configuration of a robot control system according to one embodiment of the invention.

FIG. 5 illustratively shows an exclusion zone according to one embodiment of the invention.

FIGS. 6A to 6C illustratively show how to determine the number of robots capable of occupying an exclusion zone according to one embodiment of the invention.

### DETAILED DESCRIPTION OF THE INVENTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures and characteristics described herein may be implemented as modified from one embodiment to another without departing from the spirit and scope of the invention. Furthermore, it shall be understood that the positions or arrangements of individual elements within each embodiment may also be modified without departing from the spirit and scope of the invention. Therefore, the following detailed description is not to be taken in a limiting sense, and the scope of the invention is to be taken as encompassing the scope of the appended claims and all equivalents thereof. In the drawings, like reference numerals refer to the same or similar elements throughout the several views.

Hereinafter, various preferred embodiments of the present invention will be described in detail with reference to the accompanying drawings to enable those skilled in the art to easily implement the invention.

### Configuration of the Entire System

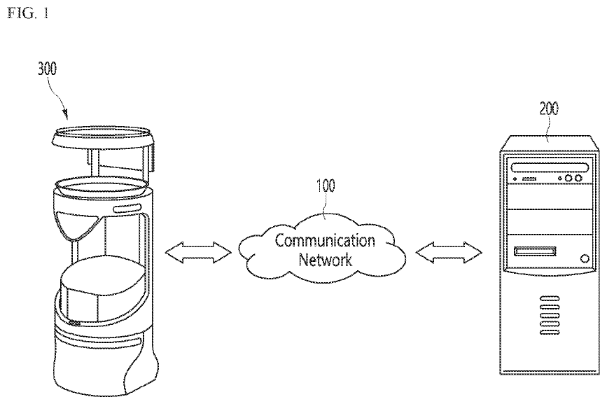

FIG. 1 schematically shows the configuration of the entire system for controlling a robot according to one embodiment of the invention.

As shown in FIG. 1, the entire system according to one embodiment of the invention may comprise a communication network 100, a robot control system 200, and a robot 300.

First, the communication network 100 according to one embodiment of the invention may be implemented regardless of communication modality such as wired and wireless communications, and may be constructed from a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired/wireless data communication networks, known telephone networks, or known wired/wireless television communication networks.

For example, the communication network 100 may be a wireless data communication network, at least a part of which may be implemented with a conventional communication scheme such as WiFi communication, WiFi-Direct communication, Long Term Evolution (LTE) communication, 5G communication, Bluetooth communication (including Bluetooth Low Energy (BLE) communication), infrared communication, and ultrasonic communication. As another example, the communication network 100 may be an optical communication network, at least a part of which may be implemented with a conventional communication scheme such as LiFi (Light Fidelity).

Next, the robot control system 200 according to one embodiment of the invention may function to determine an exclusion zone in a space where the robot 300 travels, and determine whether the robot 300 is capable of occupying the exclusion zone.

The configuration and functions of the robot control system 200 according to the invention will be discussed in more detail below.

Next, the robot 300 according to one embodiment of the invention is a device capable of communicating with the robot control system 200 via the communication network 100 and performing predetermined functions or assigned tasks (e.g., serving food and retrieving containers) through communication with the robot control system 200, and may include a support configured to support at least one object. The robot 300 according to one embodiment of the invention may include at least one of a module (e.g., a grab or a robotic arm module) for loading and unloading an object (e.g., a food tray), an imaging module (e.g., a visible light camera or an infrared camera) for acquiring images of surroundings, a scanner module (e.g., a LIDAR sensor) for acquiring information on obstacles, a sound acquisition module (e.g., a microphone) for acquiring sounds of surroundings, an illuminance acquisition module (e.g., an illuminance sensor) for sensing brightness of surroundings, a speaker module for providing sound information, a display module (e.g., LCD) for providing visual information such as text information, a light emitting module (e.g., LED) for providing visual information such as color information, and a drive module (e.g., a motor) for moving the robot 300.

For example, the robot 300 may have characteristics or functions similar to those of at least one of a serving robot, a guide robot, a transport robot, a cleaning robot, a medical robot, an entertainment robot, a pet robot, and an unmanned flying robot. Meanwhile, supporting of an object herein should be interpreted as encompassing supporting of a container for containing an object such as food, a means where the container may be placed (e.g., a tray), or the like.

Meanwhile, according to one embodiment of the invention, the robot 300 may include an application (not shown) for controlling the robot 300 according to the invention. The application may be downloaded from the robot control system 200 or an external application distribution server (not shown). According to one embodiment of the invention, the characteristics of the application may be generally similar to those of a first determination unit 210, a second determination unit 220, a communication unit 230, and a control unit 240 of the robot control system 200 to be described below. Here, at least a part of the application may be replaced with a hardware device or a firmware device that may perform a substantially equal or equivalent function, as necessary.

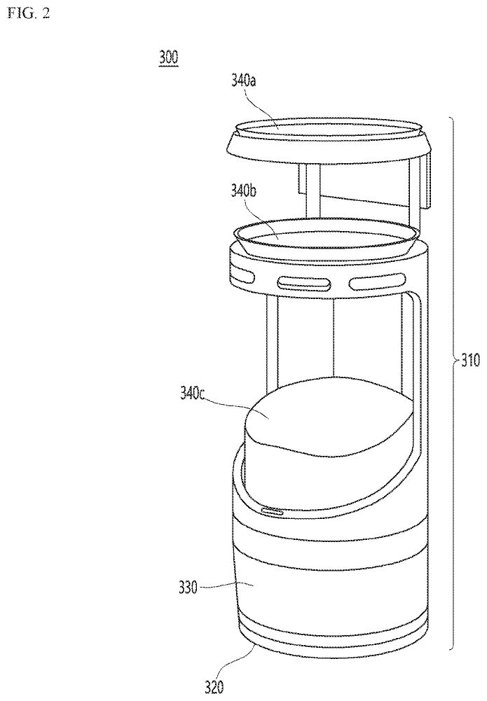

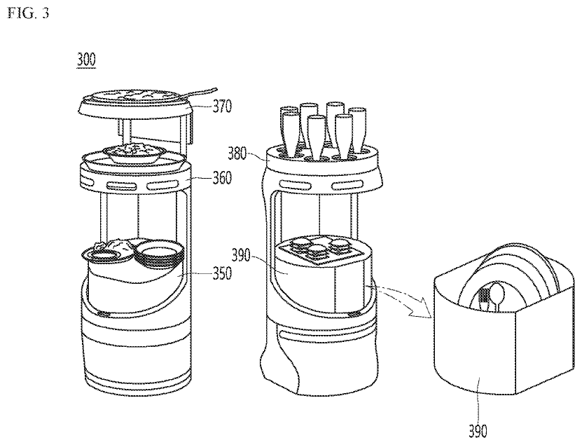

FIGS. 2 and 3 illustratively show the structure of the robot 300 according to one embodiment of the invention.

Referring to FIG. 2, the robot 300 may comprise a main body 310, a drive unit 320, and a processor 330.

First, the main body 310 according to one embodiment of the invention may be coupled to supports 340a, 340b, and 340c configured to support at least one object. According to one embodiment of the invention, the supports 340a, 340b, and 340c may be removably coupled for cleaning, replacement, or the like. Further, each of the supports 340a, 340b, and 340c may include a weight sensor (not shown) for sensing a weight supported by each of the supports 340a, 340b, and 340c. According to one embodiment of the invention, the weight sensor may be implemented using one or more strain gauges (e.g., three strain gauges, four strain gauges, or the like). In addition, according to one embodiment of the invention, the weight sensor may be coupled to the processor 330.

Further, the main body 310 according to one embodiment of the invention may include a photographing module (not shown) configured to face a spatial region above each of the supports 340a, 340b, and 340c, in place of or in addition to the weight sensor. Meanwhile, according to one embodiment of the invention, the photographing modules configured to face the spatial regions above the respective supports 340a, 340b, and 340c are not necessarily included in the main body 310, and at least some of the photographing modules may be installed on a structure in a serving place.

Meanwhile, the main body 310 according to one embodiment of the invention may include at least one loading space for loading an object. Further, according to one embodiment of the invention, the at least one loading space may include the supports 340a, 340b, and 340c. The object according to one embodiment of the invention may refer to all material objects that can be moved by the robot 300, and may encompass things, animals, and the like. For example, the object according to one embodiment of the invention may include a serving object such as food and a bussing object such as a container containing the food.

Referring to FIG. 3, the robot 300 according to one embodiment of the invention may include a first space 350 and a second space 360 for providing a serving object (i.e., serving) and collecting a bussing object (i.e., bussing). Further, the robot 300 may further include a third space 370 that is an expansion space provided via a removable pillar, and more loading spaces may be provided by adding more expansion spaces as needed. Further, the robot 300 may further include a tray 380 dedicated for the serving object or the bussing object. For example, the tray 380 may be configured such that a plurality of circular grooves are formed on its top side as seen from the top. Each of the circular grooves may be formed such that the lower part of a cup containing a drink is seated and easily fixed to some extent. The sizes of the circular grooves may be diverse. Further, the lower part of the first space 350 of the robot 300 may include a fourth space 390 that may be taken out through a lateral side of the robot 300. The fourth space 390 according to one embodiment of the invention may have a shape similar to a basket, such that an empty space is formed therein; a lateral side thereof is closed; a top side thereof is open; and a bottom side thereof is closed. However, the loading spaces of the robot 300 according to the invention are not necessarily limited to the above description, and may be diversely implemented as other types of loading spaces as long as the objects of the invention may be achieved.

Next, referring to FIG. 2 again, the drive unit 320 according to one embodiment of the invention may comprise a module for moving the main body 310 to other locations. For example, the drive unit 320 may include a module related to electrically, mechanically, or hydraulically driven wheels, propellers, or the like as the module for moving the main body 310 to other locations.

Next, the processor 330 according to one embodiment of the invention may be electrically connected to the drive unit 320 to perform a function of controlling the drive unit 320 (and may include a communication module for communicating with an external system). For example, the processor 330 may be a data processing device that are embedded in hardware and have circuits physically structured to perform codes included in a program or functions represented by instructions. For example, such a data processing device embedded in hardware may include a processing device such as a microprocessor, a central processing unit, a processor core, a multiprocessor, an application-specific integrated circuit (ASIC), and a field programmable gate array (FPGA).

Further, the processor 330 may perform the functions of at least one of the first determination unit 210 and the second determination unit 220 of the robot control system 200 according to the invention (e.g., the corresponding functions may be modularized and included in the processor 330), and may function to control the drive unit 320 through communication with an external system (not shown) that performs the functions of at least one of the first determination unit 210 and the second determination unit 220.

Specifically, the processor 330 may function to determine an exclusion zone in a space where the robot 300 travels, and determine whether the robot 300 is capable of occupying the exclusion zone.

### Configuration of the Robot Control System

Hereinafter, the internal configuration of the robot control system 200 crucial for implementing the invention and the functions of the respective components thereof will be discussed.

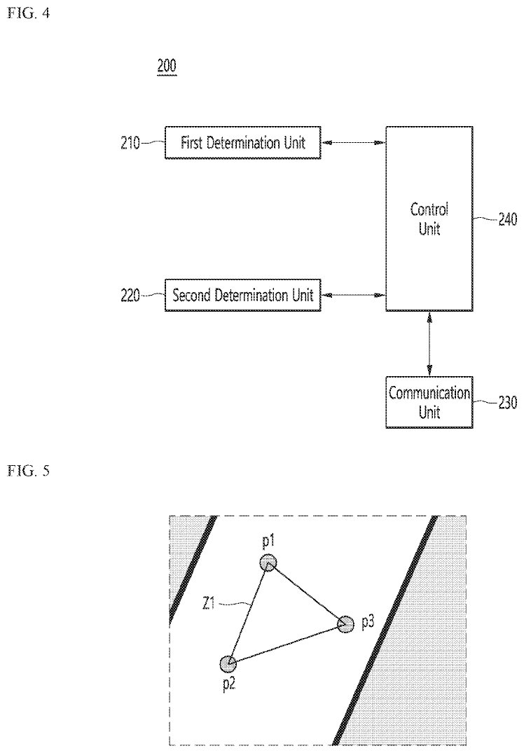

FIG. 4 specifically shows the internal configuration of the robot control system 200 according to one embodiment of the invention.

As shown in FIG. 4, the robot control system 200 according to one embodiment of the invention may comprise a first determination unit 210, a second determination unit 220, a communication unit 230, and a control unit 240. According to one embodiment of the invention, at least some of the first determination unit 210, the second determination unit 220, the communication unit 230, and the control unit 240 may be program modules that communicate with an external system. The program modules may be included in the robot control system 200 in the form of operating systems, application program modules, and other program modules, while they may be physically stored in a variety of commonly known storage devices. Further, the program modules may also be stored in a remote storage device that may communicate with the robot control system 200. Meanwhile, such program modules may include, but are not limited to, routines, subroutines, programs, objects, components, and data structures for performing specific tasks or executing specific abstract data types according to the invention as will be described below.

Meanwhile, the above description is illustrative although the robot control system 200 has been described as above, and it will be apparent to those skilled in the art that at least a part of the components or functions of the robot control system 200 may be implemented or included in the robot 300 or an external system (not shown), as necessary. Further, in some cases, all of the functions and components of the robot control system 200 may be implemented or included in the robot 300.

First, according to one embodiment of the invention, the first determination unit 210 may function to determine (or generate) an exclusion zone in a space where the robot 300 travels.

According to one embodiment of the invention, the exclusion zone may be set by a user (e.g., an administrator of the space). Specifically, the user may view the space where the robot travels (or a floor plan thereof) via a display module provided in the robot 300 or a personal device (e.g., a smartphone or laptop), and delimit the space to set the exclusion zone. Here, delimiting the space may include selecting at least three points in the space.

According to one embodiment of the invention, the first determination unit 210 may determine the exclusion zone in the shape of a polygon that has at least three points selected by the user as its vertices. Here, the shape of the polygon may include various shapes such as a triangle, a square, and the like. For example, referring to FIG. 5, the first determination unit 210 may determine an exclusion zone Z1 in the shape of a triangle that has three points p1, p2, and p3 selected by the user as its vertices.

According to one embodiment of the invention, the shape and/or position of the exclusion zone may be modified even after the determination of the exclusion zone is complete. For example, the user may modify the shape and/or position of the exclusion zone by changing the properties of the vertices (e.g., changing the positions of the vertices or changing the number of the vertices), and the first determination unit 210 may determine a new exclusion zone with reference to the properties of the vertices changed by the user.

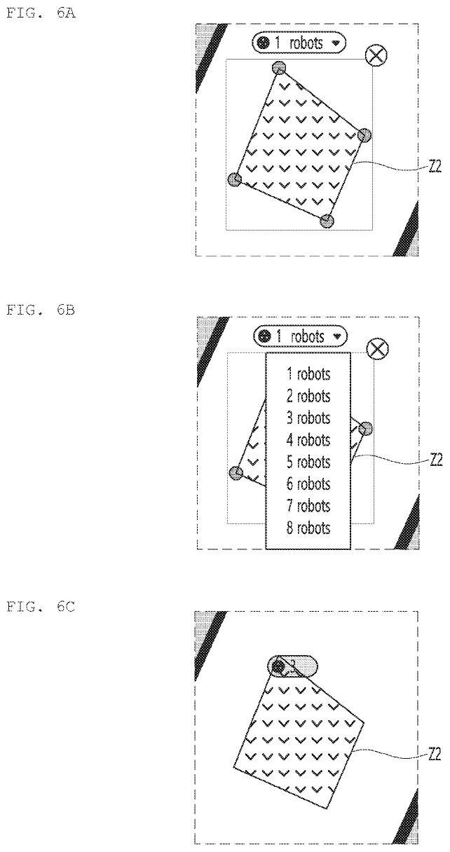

Meanwhile, according to one embodiment of the invention, the first determination unit 210 may dynamically determine the number of robots capable of occupying the exclusion zone determined as above. For example, referring to FIG. 6A, a default value (e.g., one) for the number of robots capable of occupying an exclusion zone Z2 may be determined. Further, referring to FIG. 6B, the default value may be changed so that the number of robots capable of occupying the exclusion zone Z2 is determined to be different from the default value. FIG. 6C illustrates a situation in which the number of robots capable of occupying the exclusion zone Z2 is determined to be three. The determination may be made, for example, by allowing the user to set the number of robots and transmitting information on the setting to the first determination unit 210.

Further, according to one embodiment of the invention, the first determination unit 210 may dynamically determine the number of robots capable of occupying the exclusion zone determined as above in a predetermined time range. Specifically, when determining the number of robots capable of occupying the exclusion zone, the first determination unit 210 may determine the number of robots capable of occupying the exclusion zone for each predetermined time range. For example, the first determination unit 210 may determine that the number of robots capable of occupying the exclusion zone is three for a time range from 1:00 p.m. to 3:00 p.m., and the number of robots capable of occupying the exclusion zone is five for a time range from 3:00 p.m. to 5:00 p.m. The determination may be made, for example, by allowing the user to set the time range and the number of robots and transmitting information on the setting to the first determination unit 210.

Next, according to one embodiment of the invention, the second determination unit 220 may function to determine whether the robot 300 is capable of occupying the exclusion zone.

First, according to one embodiment of the invention, the second determination unit 220 may determine whether the robot 300 attempts to occupy the exclusion zone. Here, the case where the robot 300 attempts to occupy the exclusion zone may include, for example, the case where the robot 300's travel path overlaps the exclusion zone, and the case where the robot 300 is positioned within a predetermined distance with respect to the exclusion zone.

Next, according to one embodiment of the invention, in response to the robot 300 attempting to occupy the exclusion zone, the second determination unit 220 may determine whether the robot 300 possesses a right to occupy the exclusion zone. Here, the right to occupy the exclusion zone may be in the form of a digital certificate such as a token, but is not necessarily limited thereto. Further, the number of rights to occupy the exclusion zone may correspond to the number of robots capable of occupying the exclusion zone.

Specifically, according to one embodiment of the invention, the second determination unit 220 may determine whether any right to occupy the exclusion zone is available (or surplus) on the basis of information received by the robot 300 from other robots (or information received by the robot 300 through advertising of other robots). In response to no right to occupy the exclusion zone being available (or surplus), the second determination unit 220 may determine that the robot 300 is positioned outside the exclusion zone until any right becomes available (or surplus). Further, in response to any right to occupy the exclusion zone becoming available (or surplus), the second determination unit 220 may allow the robot 300 to possess the right.

Next, according to one embodiment of the invention, in response to the robot 300 possessing (or coming to possess) the right to occupy the exclusion zone, the second determination unit 220 may allow the robot 300 to occupy the exclusion zone. Further, according to one embodiment of the invention, in response to the robot 300 possessing (or coming to possess) the right to occupy the exclusion zone, the second determination unit 220 may cause the robot 300 to advertise the possession of the right.

Here, according to one embodiment of the invention, when causing the robot 300 to advertise the possession of the right, the second determination unit 220 may cause the robot 300 to advertise a time of possessing the right as well as the possession of the right. If there is a contest between the robot 300 and another robot for the right to occupy the exclusion zone, the second determination unit 220 may determine which robot has priority for the right on the basis of each robot's time of possessing the right. Specifically, the second determination unit 220 may determine that the robot whose time of possessing the right is earlier has priority for the right. The second determination unit 220 may cause the robot 300 deprived of the right to occupy the exclusion zone as a result of the contest to stop the advertising.

Meanwhile, according to one embodiment of the invention, in response to the robot 300 that possesses the right to occupy the exclusion zone ceasing to occupy the exclusion zone, the second determination unit 220 may cause the robot 300 to stop the advertising. Further, in response to the robot 300 that possesses the right to occupy the exclusion zone ceasing to occupy the exclusion zone, the second determination unit 220 may cause the robot 300 to abandon the right to occupy the exclusion zone.

As described above, the present invention may ensure that only a specified number of robots occupy an exclusion zone. The shape and position of the exclusion zone may be determined to meet the user's intention. For example, in order to reduce congestion in a kitchen area of a restaurant, the exclusion zone may be shaped and positioned to cover the kitchen area. In this case, only a specified number of robots may be allowed to occupy the exclusion zone, and other robots may be prohibited from occupying the exclusion zone. As a result, the congestion in the kitchen area of the restaurant can be significantly reduced by utilizing the exclusion zone. This not only increases the efficiency of space operation, but also increases the efficiency of robot operation.

Next, the communication unit 230 according to one embodiment of the invention may function to enable data transmission/reception from/to the first determination unit 210 and the second determination unit 220.

Lastly, the control unit 240 according to one embodiment of the invention may function to control data flow among the first determination unit 210, the second determination unit 220, and the communication unit 230. That is, the control unit 240 according to one embodiment of the invention may control data flow into/out of the robot control system 200 or data flow among the respective components of the robot control system 200, such that the first determination unit 210, the second determination unit 220, and the communication unit 230 may carry out their particular functions, respectively.

The embodiments according to the invention as described above may be implemented in the form of program instructions that can be executed by various computer components, and may be stored on a computer-readable recording medium. The computer-readable recording medium may include program instructions, data files, and data structures, separately or in combination. The program instructions stored on the computer-readable recording medium may be specially designed and configured for the present invention, or may also be known and available to those skilled in the computer software field. Examples of the computer-readable recording medium include the following: magnetic media such as hard disks, floppy disks and magnetic tapes; optical media such as compact disk-read only memory (CD-ROM) and digital versatile disks (DVDs); magneto-optical media such as floptical disks; and hardware devices such as read-only memory (ROM), random access memory (RAM) and flash memory, which are specially configured to store and execute program instructions. Examples of the program instructions include not only machine language codes created by a compiler, but also high-level language codes that can be executed by a computer using an interpreter. The above hardware devices may be changed to one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

1. A method for controlling a robot, the method comprising the steps of:
(a) determining an exclusion zone in a space where a robot travels; and
(b) determining whether the robot is capable of occupying the exclusion zone.

2. The method of claim 1, wherein the exclusion zone is determined by selecting at least three points in the space.

3. The method of claim 2, wherein the exclusion zone is determined in a shape of a polygon that has the at least three points as its vertices.

4. The method of claim 1, wherein in step (a), a number of robots capable of occupying the exclusion zone is dynamically determined.

5. The method of claim 1, wherein in step (a), a number of robots capable of occupying the exclusion zone in a predetermined time range is dynamically determined.

6. The method of claim 1, wherein in step (b), in response to the robot possessing a right to occupy the exclusion zone, the robot is allowed to occupy the exclusion zone.

7. The method of claim 1, wherein in step (b), in response to the robot possessing a right to occupy the exclusion zone, the robot is caused to advertise the possession of the right.

8. The method of claim 1, wherein in step (b), in response to the robot possessing a right to occupy the exclusion zone, the robot is caused to advertise a time of possessing the right as well as the possession of the right.

9. A non-transitory computer-readable recording medium having stored thereon a computer program for executing the method of claim 1.

10. A system for controlling a robot, the system comprising:
a first determination unit configured to determine an exclusion zone in a space where a robot travels; and
a second determination unit configured to determine whether the robot is capable of occupying the exclusion zone.

11. The system of claim 10, wherein the exclusion zone is determined by selecting at least three points in the space.

12. The system of claim 11, wherein the exclusion zone is determined in a shape of a polygon that has the at least three points as its vertices.

13. The system of claim 10, wherein the first determination unit is configured to dynamically determine a number of robots capable of occupying the exclusion zone.

14. The system of claim 10, wherein the first determination unit is configured to dynamically determine a number of robots capable of occupying the exclusion zone in a predetermined time range.

15. The system of claim 10, wherein the second determination unit is configured to, in response to the robot possessing a right to occupy the exclusion zone, allow the robot to occupy the exclusion zone.

16. The system of claim 10, wherein the second determination unit is configured to, in response to the robot possessing a right to occupy the exclusion zone, cause the robot to advertise the possession of the right.

17. The system of claim 10, wherein the second determination unit is configured to, in response to the robot possessing a right to occupy the exclusion zone, cause the robot to advertise a time of possessing the right as well as the possession of the right.
